(19) United States
(12) Patent Application Publication
(10) Pub. No.: US 2014/0061187 A1
(43) Pub. Date: Mar. 6, 2014

(54) APPARATUS FOR HEATING BY ELECTROMAGNETIC INDUCTION, IN PARTICULAR INDUCTION HEATING OR INDUCTION FURNACE

(71) Applicant: AEG POWER SOLUTIONS B.V., Zwanenburg (NL)

(72) Inventor: Peter Wallmeier, Lippstadt (DE)

(73) Assignee: AEG POWER SOLUTIONS B.V., Zwanenburg (NL)

(21) Appl. No.: 13/795,092

(22) Filed: Mar. 12, 2013

(30) Foreign Application Priority Data
Aug. 28, 2012 (EP) 12 182 061.7

(51) Int. Cl. H05B 6/10

(52) U.S. Cl. CPC H05B 6/10
USPC 219/671

(57) ABSTRACT

An apparatus for heating by electromagnetic induction heating e.g., for heating silicon carbide, with a first power supply arrangement (1) having an output with two terminals (11, 12), with a second power supply arrangement (2) for providing an n-phase multi-phase AC voltage at n outputs, each output having two terminals (21, 22, 23). The phase shift between the chained voltages (U12, U21) of the n-phase multi-phase AC voltage provided at output side of second power supply arrangement is 360°/n. The n outputs of the second power supply arrangement (2) form a chain: two terminals are assigned to n-2 outputs, in two outputs of the n outputs have only one terminal (22), which is also associated with another output, whereas the other terminals (21, 23) of these two outputs are associated only with one output and wherein these terminals (21, 23) form the beginning and the end of the chain.

### BACKGROUND OF THE INVENTION

(1) Field of the Invention

The present invention relates to an apparatus for heating by electromagnetic induction, in particular induction heating or induction furnace, for example for heating silicon carbide,
with a first power supply arrangement with an output with two terminals,
with a second power supply arrangement for providing n-phase multi-phase AC voltage to n outputs, each output having two terminals, wherein the phase shift between chained voltages on the n-phase multi-phase AC voltage provided at the output side of the second power supply arrangement is 360°/n, and wherein n is a natural number greater than or equal to two,
wherein the n outputs of the second current supply arrangements form a chain, in that two terminals which are assigned at the same time also to a respective other of the outputs are assigned to n-2 outputs among the n outputs, and that two outputs of the n outputs have only one connection, which is also assigned to a different output, while the other terminals of these two outputs are associated with only one output, and these connections form the beginning and the end of the chain,
   wherein one of the chained voltages of the n-phase alternating current system is present at each output of the second power supply arrangement.

(2) Description of Related Art

An apparatus with the aforementioned features is known from the unpublished European Patent Application No. 11 174 546.9 by the same applicant. However, this application does not disclose that the device can be used for inductive heating. Instead, the apparatus disclosed in the earlier European patent application 11 174 546.9 is used for heating silicon rods or thin silicon rods that can be connected to the outputs.

The documents EP 2100851 A2 and EP 2346150 A1 also disclose apparatuses for heating having the features of the aforementioned apparatus, wherein n equals two for the apparatuses described in these documents. The apparatuses described in EP 2100851 A2 and EP 2346150 A1 are also used for heating silicon rods or thin silicon rods.

It is known in the art to heat silicon carbide for further processing. Silicon carbide is not sufficiently conducting at room temperature. However, the conductivity increases when it is heated, as observed in studies published as early as 1946 (See, “The electrical conductivity of silicon carbide” in Helvetica Physica Acta, Volume 19, page 167, 1946). A silicon carbide rod whose ends are connected to the output of a voltage source cannot be sufficiently heated at room temperature solely by an electric current. Heating by electromagnetic induction from eddy currents is also not possible when the silicon carbide rod is cold. A silicon carbide rod must therefore be heated with an external heat source before becoming sufficiently conducting and reaching the maximum conductivity at temperatures of 400 to 1200° C. depending on the purity. It is known to further heat already heated electrically conductive silicon carbide by electromagnetic induction.

Other materials exhibit a behavior similar to silicon carbide.

Until now, these materials were first heated by convection heaters. However, heating by convection is not very effective and also takes a long time.

This is the starting point for the present invention.

### BRIEF SUMMARY OF THE INVENTION

It is the object of the present invention to propose an apparatus for heating by electromagnetic induction, which is suitable and configured to heat materials that are not electrically conductive at room temperature.

This object is attained with the invention in that an apparatus of the aforedescribed type
has at least n inductors,
wherein the inductors are connected to the output of the first power supply arrangement in series with respect to the first power supply arrangement, and
wherein at least one respective inductor is connected to an output of the outputs of the second power supply arrangement.

The first power supply arrangement is used to heat the inductors by a current flow, so that this radiant heat can be transferred to a material incorporated in the inductors. When the material is sufficiently heated and electrically conducting, eddy currents are generated in the material by the second power supply arrangement and the electromagnetic alternating fields generated in the inductors, which very effectively continue to heat the material.

Preferably, n is a number divisible by two. The outputs of the second power-supply arrangement can then be associated with each other in pairs. Chained voltages with a phase shift of 180° may be present at the outputs of a pair. The outputs of such a pair need not have any common connections, but may do so. Because voltages with a 180° phase-shift, i.e. opposing voltages are present at the outputs of the pairs, there is a possibility that no sum voltage provided by the second power supply arrangement drops across the entire chain of the outputs of the second power-supply arrangement. This has the advantage that no current can be driven from the second power supply arrangement into the first power supply arrangement, to the output of which the series inductors are connected.

It is particularly advantageous when the inductors connected to the outputs of a pair have an opposite winding sense. It is then possible that in spite of the opposite voltages present at the outputs of a pair, these voltages produce in the workpiece electromagnetic fields having identical direction that amplify each other.

The inductors can be wound from a wire having a specific resistance at room temperature that can be selected as a function of the rated power, the rated current and/or the nominal output power of the first power-supply arrangement. The wire may have a negative or a positive temperature coefficient. With a negative temperature coefficient, the conductivity of the inductors advantageously increases with increasing temperature. This allows higher currents to flow through the inductors with sufficient heating, which then generate stronger electromagnetic fields than would be possible with cold inductors. The effect of the resistive heating operated substantially by the first power-supply arrangement thus decreases with increasing heat-up, whereas the effect of the induction heating operated by the second power supply arrangement becomes stronger.

The first power supply arrangement advantageously provides an alternating voltage with a frequency of up to 100 Hz. The frequency of the voltages provided by the second power supply arrangement is advantageously from 1 to 100 kHz.

The first power supply arrangement advantageously provides an AC voltage of up to 10 to 1000 V. The magnitudes of the voltages provided by the second power supply arrangement are advantageously 10 to 1000 V.

The apparatus according to the invention may include a control device, with which the voltage at the output of the first power supply arrangement and/or the voltage at the outputs of the second power supply arrangement can be adjusted. The control device may be suitable and configured to adjust a voltage at the output of the first power supply arrangement when a material placed in the inductors starts to heat up, with the voltage being reduced with increasing heating and/or electrical conductivity of the material. The control device may also be suitable and configured to adjust voltages at the outputs of the second current supply arrangement when a material placed in the inductors starts to heat up, with the voltage being increased with increasing heating and/or electrical conductivity of the material.

According to the invention, the device may include a temperature sensor for measuring the temperature of the workpiece to be heated. This sensor may be connected to the control device. The control device can control as a function of the temperature whether the output power from the first power supply arrangement is greater than the output power from the second power supply arrangement and/or which power is adjusted at which current supply arrangement.

### BRIEF DESCRIPTION OF THE SEVERAL VIEWS OF THE DRAWING(S)

An apparatus according to the invention will now be described with reference to the drawing, which shows in

FIG. 1 an apparatus according to the invention for heating by electromagnetic induction.

### DETAILED DESCRIPTION OF THE INVENTION

The apparatus according to the invention for heating by electromagnetic induction includes a first power supply arrangement 1 having an output with two terminals 11, 12. The apparatus according to the invention further includes a second power supply arrangement 2.

The second power supply arrangement 2 has two outputs, which are each formed by two terminals 21, 22, 23. A first of the two outputs is formed by the terminals 21, 22 and a second of the outputs is formed by the terminals 22, 23. The terminal 22 is thus used by both the first output and the second output, whereas the terminals 21, 23 are used by only one of the two outputs.

The two outputs of the second current supply device 2 form a chain of outputs, which begins with the terminal 21 and ends with the terminal 23.

An inductor 31, 32 is connected to each output of the second current supply arrangement 2. The inductor 31 is connected to the terminals 21 and 22. The inductor 32 is connected to the terminals 22 and 23. The inductors 31, 32 are also connected to the output of the first power supply arrangement 1. From the perspective of the first power supply arrangement 1, the two inductors 31, 32 form a series circuit which is connected to the terminals 11, 12 of the first power-supply arrangement.

The first power supply arrangement 1 is used to supply a low-frequency voltage to the inductors 31, 32. Conversely, the second power supply arrangement 2 supplies a comparatively high-frequency voltage to the inductors 31, 32.

Voltages having a mutual phase-shift of 180° and identical magnitude and frequency are present at the outputs of the second power supply arrangement 2. As a result, there is no voltage drop between the terminals 21 and 23. The outputs of the second power supply arrangement 2 form a two-phase AC system with two phase conductors, wherein one phase conductor is connected to the terminals 21, 23 and the other phase conductor is connected to the terminal 22. The chained voltages of the two-phase alternating current system are present at the outputs. The term “chained voltages” refers to the voltages between the phase conductors of the 2-phase AC system.

Because the terminals 21, 23 of the second power supply arrangement 2 are at the same potential, the second power supply arrangement 2 is unable to feed current to the first power supply arrangement 1. The first power supply arrangement 1 is thus decoupled from the second power supply arrangement 2.

To also decouple the second power supply arrangement 2 from the first power supply arrangement 1, high-pass filters, for example capacitors, may be inserted in the phase conductors leading to the terminals 21, 22 and/or 23.

The second power supply arrangement may have three outputs. The power supply arrangement would then have an additional terminal, which could form the end of the chain of the outputs instead of, for example, the terminal 23. The terminal 23 could then be used not only by the second output, but also by the third output. This second power supply arrangement would then provide at the output side a three-phase AC system with three phases having a mutual phase-shift of 120°.

Likewise, the second power supply arrangement may have four outputs. Two additional outputs would then be provided compared to the illustrated second power supply arrangement, of which one forms the end of the chain of the outputs of the second power supply arrangement instead of the terminal 23. The terminal 23 and the other additional terminal would be assigned to the third output. The other additional terminal would be assigned additionally to the fourth output. The second power supply arrangement would then advantageously provide at the output a four-phase AC power system, with four phases having a mutual phase-shift of 90°.

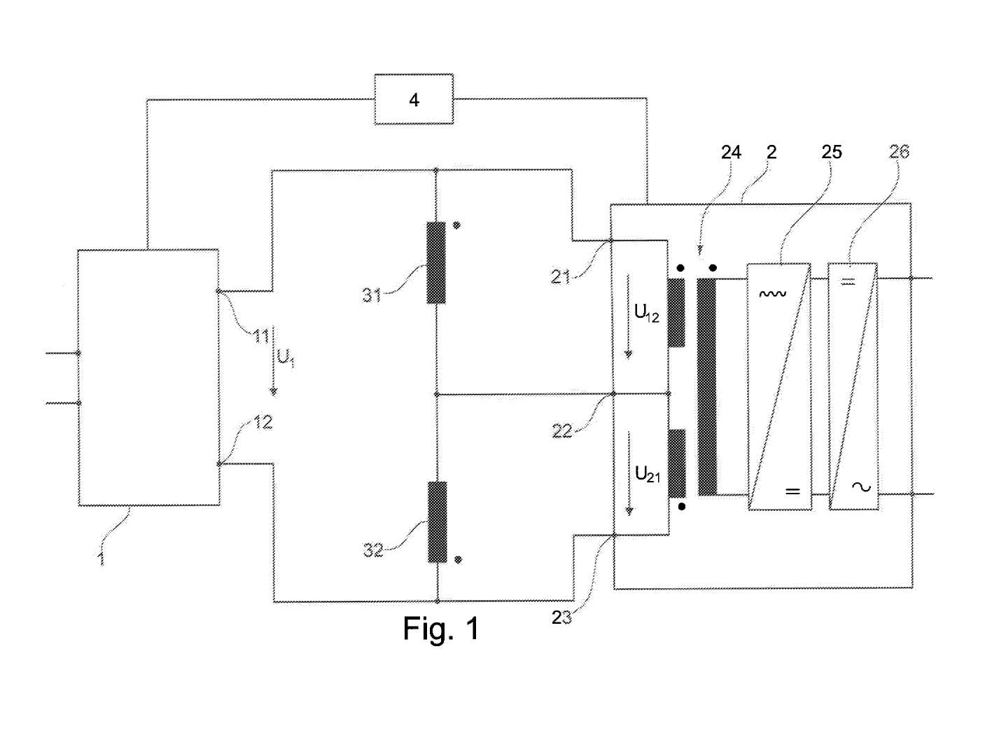

It is essentially irrelevant for the invention, how the second power supply arrangement 2 is constructed in order to provide at the terminals 21, 22, 23 chained voltages with a relative phase-shift of 180°. A simple example for generating such voltages with the second power supply arrangement 2 is shown in FIG. 1. This illustrated second power supply arrangement 2 has a frequency converter 25, 26, which is formed by a rectifier 26 and an inverter 25 connected downstream of the rectifier. A transformer 24 with a primary winding and a secondary winding is connected to the output of the frequency converter 25, 26, wherein the secondary winding has a center tap, which is connected to the terminal 22 of the second power supply arrangement 2. Outside taps of the secondary winding are connected to the terminals 21, 23. The sections of the secondary winding between the terminal 21 and 22, on one hand, and between the terminals 22 and 23, on the other hand, have opposite winding directions. For an identical number of turns, opposite voltages are then produced at the outputs of the second power supply arrangement 2 for the same magnetic flux passing through the secondary winding sections.

When the second power supply arrangement 2 has four outputs, it may include two frequency converters 25, 26 and two transformers 24. The second power supply arrangement may also have a cycloconverter, which provides a multi-phase alternating current.

The inductors may advantageously have opposing winding directions. The opposing winding direction of the different inductors 31, 32 causes the electromagnetic fields generated by the inductors 31, 32 with opposite voltages to point in the same direction and to amplify each other. A workpiece (not shown), which is immersed in the inductors, is then exposed to a particularly strong electromagnetic field when the inductors 31, 32 are powered by the second power supply arrangement 2.

The apparatus according to the invention includes a control device 4, which controls the first power supply arrangement 1 and the second power supply arrangement 2.

What is claimed is:

1. An apparatus for heating by electromagnetic induction, comprising
a first power supply arrangement (1) having an output with two terminals (11, 12),
a second power supply arrangement (2) for providing an n-phase multi-phase AC voltage at n outputs, each output having two terminals (21, 22, 23), wherein the phase shift between the chained voltages (U12, U21) of the n-phase multi-phase AC voltage provided at an output side of the second power supply arrangement is 360°/n, and wherein n is a natural number greater than or equal to two,
wherein the n outputs of the second power supply arrangement (2) form a chain, in that two terminals are assigned to n-2 outputs among the n outputs, which are also associated with another one of the outputs, and in that two outputs of the n outputs have only one terminal (22), which is also associated with another output, whereas the other terminals (21, 23) of these two outputs are associated with only one output and wherein these terminals (21, 23) form the beginning and the end of the chain,
wherein one of the chained voltages (U12, U21) of the n-phase alternating current system is present at each output of the second current supply arrangement (2),
the apparatus further comprising
at least n inductors (31, 32),
wherein the inductors (31, 32) are connected in series to the output of the first power supply arrangement with respect to the first power supply arrangement (1), and
wherein at least one respective inductor (31, 32) is connected to an output of the outputs of the second power supply arrangement.

2. The apparatus according to claim 1, wherein n is a number divisible by two, that the outputs of the second power supply arrangement (2) are associated with each other in pairs and that chained voltages (U12, U21) with a phase shift of 180° are present at the outputs of a pair.

3. The apparatus according to claim 2, wherein the inductors (31, 32) connected to the outputs of a pair of outputs have opposite winding directions.

4. The apparatus according to claim 1, wherein the wire has a negative temperature coefficient.

5. The apparatus according to claim 1, wherein the device comprises a control device (4), with which the voltage (U1) at the output of the first power supply arrangement (1) and/or the voltages (U12, U21) at the outputs of the second power supply arrangement (2) can be adjusted.

6. The apparatus according to claim 5, wherein the control device (4) is configured to adjust the voltage (U1) at the output of the first power supply arrangement (1), when a material introduced into the inductors (31, 32) starts to heat up, wherein the voltage (U1) is reduced with increasing heating and/or electrical conductivity of the material.

7. The apparatus according to claim 5, wherein the control device (4) configured to adjust the voltages (U12, U21) at the outputs of the second power supply arrangement (2), when a material introduced into the inductors (31, 32) starts to heat up, wherein the voltage (U1) is increased with increasing heating and/or electrical conductivity of the material.

8. The apparatus according to claim 1, wherein the heating is by electromagnetic induction, in particular induction heating or induction furnace, for example for heating silicon carbide,

9. A method for heating silicon carbide by electromagnetic comprising the steps of
providing a first power supply arrangement (1) having an output with two terminals (11, 12),
providing a second power supply arrangement (2) for providing an n-phase multi-phase AC voltage at n outputs, each output having two terminals (21, 22, 23), wherein the phase shift between the chained voltages (U12, U21) of the n-phase multi-phase AC voltage provided at an output side of the second power supply arrangement is 360°/n, and wherein n is a natural number greater than or equal to two,
wherein the n outputs of the second power supply arrangement (2) form a chain, in that two terminals are assigned to n-2 outputs among the n outputs, which are also associated with another one of the outputs, and in that two outputs of the n outputs have only one terminal (22), which is also associated with another output, whereas the other terminals (21, 23) of these two outputs are associated with only one output and wherein these terminals (21, 23) form the beginning and the end of the chain,
wherein one of the chained voltages (U12, U21) of the n-phase alternating current system is present at each output of the second current supply arrangement (2),
providing at least n inductors (31, 32),
wherein the inductors (31, 32) are connected in series to the output of the first power supply arrangement with respect to the first power supply arrangement (1), and
wherein at least one respective inductor (31, 32) is connected to an output of the outputs of the second power supply arrangement.
